(19) United States
(12) Patent Application Publication
(10) Pub. No.: US 2024/0045077 A1
(43) Pub. Date: Feb. 8, 2024

(54) METHOD AND APPARATUS FOR DETERMINING A FREQUENCY RELATED PARAMETER OF A FREQUENCY SOURCE

(71) Applicant: Fecal Point Positioning Limited, Cambridge (GB)

(72) Inventors: Ramsey Michael FARAGHER, Cambridge (GB); Rebert Mark CROCKETT, Cambridge (GB); Peter James DUFFETT-SMITH, Cambridge (GB)

(21) Appl. No.: 18/228,378

(22) Filed: Jul. 31, 2023

Related U.S. Application Data
(60) Provisional application No. 63/394,667, filed on Aug. 3, 2022.

(51) Int. Cl. G01S 19/23

(52) U.S. Cl. CPC G01S 19/23

(57) ABSTRACT

A method and apparatus for determining a frequency related parameter of a frequency source. In some embodiments, the method includes receiving a plurality of signals from a plurality of remote sources; generating motion compensated correlation results using a determined receiver motion, the received signals, and a local signal derived from the local frequency source; phase compensating the motion compensated correlation results to produce phase compensated correlation results using a plurality of phasor sequences that represent frequency error of the local frequency source; and jointly analysing the phase compensated correlation results associated with the plurality of remote sources to determine a frequency related parameter of the local frequency source.

### CROSS-REFERENCE TO RELATED APPLICATIONS

This application claims priority to U.S. Provisional Patent Application Ser. No. 63/394,667, filed on Aug. 3, 2022, which is hereby incorporated by reference in its entirety.

### FIELD

Embodiments of the present invention generally relate to radio communications and, in particular, relate to a method and apparatus for determining a frequency related parameter of a frequency source used by a radio receiver.

### BACKGROUND

Modern positioning and communications devices such as cellular phones have frequency sources (e.g., local oscillators) that can provide a frequency reference for a variety of different applications. Often cellular devices comprise relatively low-cost local oscillators, such as quartz oscillators. These low-cost oscillators can provide stable frequency references over short time periods. However, the frequency reference they produce can be unstable over longer time periods, and can also be unstable when their operating conditions change. Examples of changing operating conditions include temperature, vibrations, and accelerating forces such as shocks when the device is jolted or dropped.

One application that requires a frequency reference from a local frequency source is GNSS positioning. Unlike many other applications in a cellular phone, however, GNSS positioning requires a very stable frequency reference. Such stable references are costly and increase the cost of any device requiring a very stable frequency source.

Therefore, there is a need in the art for a method and apparatus for determining a frequency related parameter, such as frequency error or offset, of a local reference signal generated by an unstable frequency source within a receiver. The frequency related parameter may be used to improve the functionality of a positioning device or communications device that relies upon an unstable local frequency source.

### SUMMARY

Embodiments of the present invention generally relate to a method and apparatus for determining a frequency related parameter of a frequency source as shown in and/or described in connection with at least one of the figures.

These and other features and advantages of the present disclosure may be appreciated from a review of the following detailed description of the present disclosure, along with the accompanying figures in which like reference numerals refer to like parts throughout.

### BRIEF DESCRIPTION OF THE DRAWINGS

Embodiments of the invention are now described, by way of example, with reference to the drawings, in which:

FIG. 1 is a diagram of a scenario in which a receiver is operated in accordance with at least one embodiment of the invention;

FIG. 2 is a functional block diagram of the receiver of FIG. 1 in accordance with at least one embodiment of the invention;

FIG. 3 is a block diagram of a computing device configured to implement a signal processor and frequency source controller in accordance with at least one embodiment of the invention;

FIGS. 4A and 4B, together, are a flow diagram of a method of determining frequency error of a frequency source in accordance with at least one embodiment of the invention; and

FIG. 5 is a series of graphs representing a joint analyses process used to calculate frequency error information in accordance with at least one embodiment of the invention.

### DETAILED DESCRIPTION

Embodiments of the present invention include a method for determining a frequency related parameter of a frequency source within a receiver, comprising: receiving a plurality of signals from a plurality of remote sources; generating motion compensated correlation results using a determined receiver motion, the received signals and a local signal derived from the frequency source; phase compensating the motion compensated correlation results to produce phase compensated correlation results using a plurality of phasor sequences that represent hypotheses of a frequency related parameter of the frequency source; and jointly analysing the phase compensated correlation results associated with the plurality of remote sources to determine a frequency related parameter of the frequency source.

Each phasor sequence in the plurality of phasor sequences have a length that is defined by the expected stability of the local frequency source. If the local frequency source is stable over a period equal to or longer than a desired coherent integration period, then the length may be the same as the coherent integration interval. However, for very unstable frequency sources, the phasor sequence length may be shortened such that multiple subinterval correlations may occur and a preferred phasor sequence in each subinterval used to produce the phase compensated correlation results.

In this way, the frequency error information may be used to facilitate use of a long coherent integration interval for signal reception and processing. Frequency errors in each subinterval can be corrected such that the entire sequence is eventually corrected. This technique facilitates coherent integration being performed even if the underlying frequency source is not stable during the entire period (interval of the received signal). This has previously not been possible, and it advantageously improves the ability of, for example, a positioning system to determine a range to a GNSS satellite in a poor positioning environment when the system itself has a relatively poor frequency source.

Embodiments of the present invention comprise apparatus and methods for improving oscillator performance in a radio receiver. Embodiments of the invention process received signals (e.g., radio signals such as WiFi, global navigation satellite system (GNSS) signals, cellular telephone signals, and the like) to determine a frequency related parameter of the receiver frequency source. In one embodiment, the frequency related parameter may be a frequency error or offset. The frequency offset may be used to improve signal processing of received signals such that, for example, weak signals may be received that otherwise could not be received. By correcting for the frequency error in this manner, the frequency source within the receiver does not have to be very accurate or be very robust to withstand environmental conditions. In one embodiment, the frequency error comprises a frequency difference between the correct frequency needed to accurately receive signals and the current frequency of the frequency source as well as including a frequency rate which is the evolution of the frequency over time. Embodiments of the invention process the received signals to facilitate removing local frequency errors such that the local frequency source is as accurate as an oscillator used in the transmitter, i.e., an atomic clock in the case of GNSS signals.

To determine the frequency error, embodiments determine the motion of the receiver using inertial navigation techniques and use the determined motion to motion compensate received signals such that the transmitted signal or signals are accurately received. Further processing of the received signal(s) facilitates determining the frequency related parameter or parameters of the local frequency source. The parameter is then used by the receiver to improve processing of the received signals. In this manner, an inexpensive, unstable frequency source may be used in the receiver and still enable the receiver to accurately receive the transmitted signals.

Many of today's radio communications systems utilize encoded digital signals to improve communication throughput and security. Most of these systems utilize some form of deterministic digital code to facilitate signal acquisition, e.g., Gold codes or other forms of acquisition code. Such a digital code is determined by the receiver and broadcast by the transmitter to enable communications receivers to find, acquire and receive the transmitted signals. Using such deterministic codes combined with accurate motion information for the receiver, embodiments of the invention are useful for identifying frequency related parameters such as frequency errors generated by frequency sources within the receiver. A technique for determining frequency related parameters using receiver motion information is known as SUPERCORRELATION™ and is described in commonly assigned U.S. Pat. No. 9,780,829, issued 3 Oct. 2017; U.S. Pat. No. 10,321,430, issued 11 Jun. 2019; U.S. Pat. No. 10,816,672, issued 27 Oct. 2020; U.S. patent publication 2020/0264317, published 20 Aug. 2020; and U.S. patent publication 2020/0319347, published 8 Oct. 2020, which are hereby incorporated herein by reference in their entireties. Upon knowing the frequency related parameters, embodiments may generate a frequency offset to correct for the error or otherwise use the known error to improve signal processing.

For example, an embodiment of the invention may be used in a GNSS signal receiver to receive a plurality of GNSS satellite transmissions. Within the receiver, the received signals are correlated with locally generated signals to produce correlation results. The receiver uses an inertial navigation system (INS) to determine the motion of the receiver and this motion is used to phase compensate the received signal, local signal and/or correlation results to produce motion compensated correlation results. The motion is used to generate phasor sequences for adjusting signal phase that are applied to complex samples of the received signals, the local signals or the correlation results to phase compensate the complex valued correlation results to compensate for receiver motion.

After the correlation results are motion compensated, embodiments of the invention then apply phase compensation to the motion compensated correlation results. The phase compensation utilizes a phasor sequence that represents the frequency related parameter. The phasor sequences are applied to the correlation results as hypotheses to be tested to identify the best or optimal hypothesis as a preferred hypothesis. If the frequency source is only stable for periods that are less than the desired coherent integration interval, then the hypotheses are short phasor sequences having a length of only a subset of motion compensated correlation results. The preferred hypotheses of each subset are concatenated to form a phasor sequence having a length of the desired coherent integration interval.

By combining the correlation results from received signals of multiple transmitters and analysing the combined (joint) results, the remaining correlation error is a common error to all the satellite signals and is a function of the receiver frequency parameter(s). The receiver generates a sequence of frequency offsets (a model) and uses the model to process the received signals or otherwise used to improve receiver function. In addition to GNSS receivers, such frequency source improvements are useful in mobile devices that utilize communications techniques that use a deterministic code, for example, but not limited to, WiFi, Bluetooth, cellular telephone, and the like.

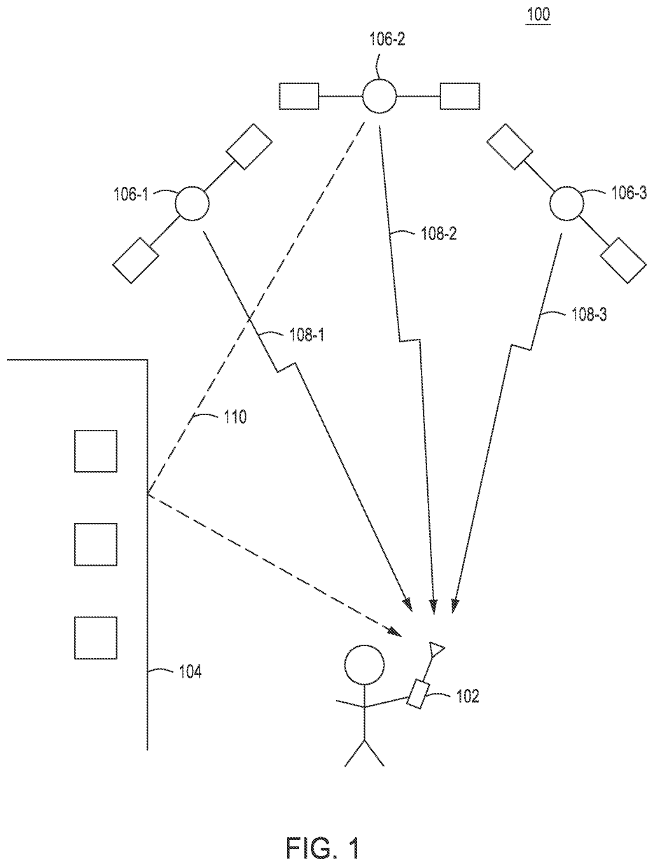

FIG. 1 depicts a block diagram of a scenario 100 having a receiver 102 that utilizes frequency source operation improvement techniques in accordance with at least one embodiment of the invention. The receiver 102 is a mobile device such as, but not limited to, cellular telephone, laptop computer, tablets, Internet of Things (IoT) devices, embedded communication/navigation systems in a vehicle, etc. The receiver 102 may be configured as a smartphone, laptop, or any other type of device capable of determining a position. The transmitters 106-1, 106-2, 106-3 (collectively, transmitters 106) respectively transmit signals 108-1, 108-2, 108-3 (collectively, signals 108). The transmitters 106 may be any form of transmitter that transmits a deterministic code, e.g., Gold code, Barker code, or some other form of repetitive acquisition code. Such transmitters include GNSS satellites, cellular telephone transmitters, WiFi transmitters, Bluetooth transmitters and the like, where the transmitters utilize a frequency source that is more accurate than the oscillator used in the receiver 102. The exemplary embodiment of FIG. 1 shows GNSS satellites as the transmitters 106. Although not shown in FIG. 1, the transmitters 106 may also include a transmitter located on the ground.

The receiver 102 receives the signals 108 and processes the signals in accordance with embodiments of the invention to improve the operation of the receiver 102. In one embodiment, the signal processing used can differentiate between direct signals 108 (i.e., signals that propagate directly from the transmitter to the receiver, sometimes referred to as line-of-sight (LOS) signals) and indirect signals 110 (i.e., signals that are reflected from an object 104, sometimes referred to as non-line-of-sight (NLOS) signals) that reflect from structures proximate the receiver 102. In one embodiment, the receiver 102 may use known satellite ephemeris or a transmitter map to determine which signals are likely to be direct signals. In other embodiments, the receiver 102 may differentiate direct and indirect signals using a SUPERCORRELATION™ technique as described in commonly assigned U.S. Pat. No. 9,780,829, issued 3 Oct. 2017; U.S. Pat. 10,321,430, issued 11 Jun. 2019; U.S. Pat. No. 10,816,672, issued 27 Oct. 2020; U.S. patent publication 2020/0264317, published 20 Aug. 2020; and U.S. patent publication 2020/0319347, published 8 Oct. 2020, which are hereby incorporated herein by reference in their entireties. The SUPERCORRELATION™ technique is also used in various embodiments of the present invention as described in detail below.

Objects 104 (e.g., tall buildings) can attenuate signals from transmitters 106-1, 106-2, 106-3 where the objects 104 block the line-of-sight between a transmitter and the receiver 102. This may reduce the signal to noise ratio of the signals received from the transmitter. In some instances, the resulting signal strengths may be too low for use in positioning calculations, unless the signals are integrated over a relatively long period (perhaps as much as 1 second, or longer) during correlation. Integrating over a longer time period time enables the receiver 102 to effectively improve the signal to noise ratio of received signals to sufficient levels to obtain an accurate position fix from the transmitters. A similar problem can arise where there are reflected signals and it is difficult for the receiver to distinguish the line-of-sight signal from the reflected signal.

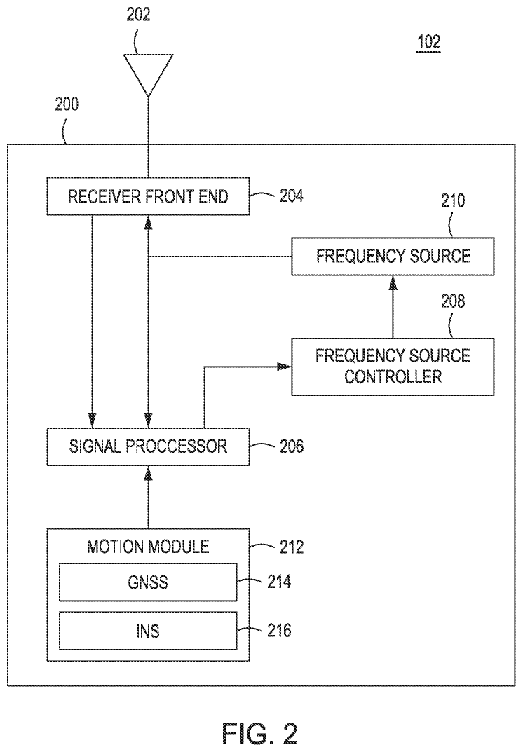

FIG. 2 depicts a block diagram of a radio receiver 102 in accordance with at least one embodiment of the invention. The receiver 102 comprises a mobile platform 200 and an antenna 202. The receiver 101 may form a portion of a laptop computer, mobile phone, tablet computer, Internet of Things (IoT) device, unmanned aerial vehicle, mobile computing system in an autonomous vehicle or human operated vehicle, and the like. In general, embodiments of the invention find use in any environment where a mobile receiver is used and the receiver uses an unstable oscillator.

In a typical mobile receiver, the mobile platform 200 and the antenna 202 are an indivisible unit (e.g., mobile phone) where the antenna 202 moves with the mobile platform 200. The operation of the SUPERCORRELATION™ technique operates based upon the motion of the signal receiving antenna. Any mention of motion or receiver motion described herein refers to the motion of the antenna 202. In some embodiments, the antenna 202 may be separate from the mobile platform 200. In such a situation, the motion estimate used in the motion compensated correlation process is the motion of the antenna 202. In most scenarios, the motion of the mobile platform 200 is the same as the motion of the antenna 202 and, as such, the following description will assume that the motion of the mobile platform 200 and antenna 202 are the same.

The mobile platform 200 comprises a receiver front end 204, a signal processor 206, frequency source controller 208, a frequency source 210 and a motion module 212. The receiver front end 204 downconverts, filters, and samples (digitizes) the received signals in a manner that is well-known to those skilled in the art. The output of the receiver front end 204 is a digital signal containing data. The data of interest is a deterministic training or acquisition code, e.g., Gold code, used by the transmitter to synchronize the transmission to a receiver.

The signal processor 206 processes signals from the receiver front end 204, i.e., the digitized received signals. The signal processor 206 utilizes receiver motion information to perform motion compensated correlation to derive frequency related parameters of the frequency source. The motion module 212 generates a motion estimate for movement of the receiver 102. The motion module 212 may comprise an inertial navigation system (INS) 216 as well as a global navigation satellite system (GNSS) receiver 214 such as a receiver for receiving signals from one or more of GPS, GLONASS, GALILEO, DEIBOU, etc., satellites. The INS 216 may comprise one or more of, but not limited to, a gyroscope, a magnetometer, an accelerometer, and the like (i.e., conventional components used in an inertial measurement unit (IMU)). To facilitate motion compensated correlation, the motion module 212 produces motion information (sometimes referred to as a motion model) comprising at least a velocity of the antenna 202 in the direction of an emitter of interest, i.e., an estimated direction along a path of signal propagation from a source of a received signal. In some embodiments, the motion information may also comprise estimates of platform orientation or heading including, but not limited to, pitch, roll and yaw of the platform 200/antenna 202.

In one embodiment where the frequency source 210 is somewhat stable over the coherent integration interval of the received signals, the frequency offset may be coupled to the frequency source controller 208 where a frequency control signal is created to optionally control the frequency source 210 (e.g., a current frequency offset is used in a closed loop manner to adjust the oscillator to receive a future transmission). The frequency source 210 provides timing signals to the signal processor 206 and the receiver front end 204 for use in received signal demodulation and processing. In other embodiments, the frequency or frequency offset may be stored in memory for use by software applications or other components of the receiver in an open loop manner. In other embodiments where the stability period of the frequency source is substantially shorter than the desired coherence interval and the frequency source cannot be adjusted to receive future transmissions, the determined frequency related parameters are used by the signal processor 206 to process the currently received signals and correlation results (buffered signals/results) and improve reception of those signals.

In operation, the receiver 102 receives a plurality of transmitter signals (signals from known remote sources). The signal processor 206 uses motion of the receiver 102 to perform motion compensated correlation (e.g., a SUPERCORRELATION™ technique) of the received signals to derive at least one frequency related parameter (e.g., frequency error). The receiver 102 uses the at least one frequency related parameter to improve processing of currently received signals and, in some cases, may improve reception of subsequently received signals. In one embodiment, the frequency source controller 208 uses the frequency error to produce a frequency correction for the frequency source 210 such that subsequently received signals may be more accurately received. In other embodiments, the signal processor 206 continuously corrects the frequency error of currently received signals' correlation results such that an unstable frequency source may be used for long periods of coherent integration.

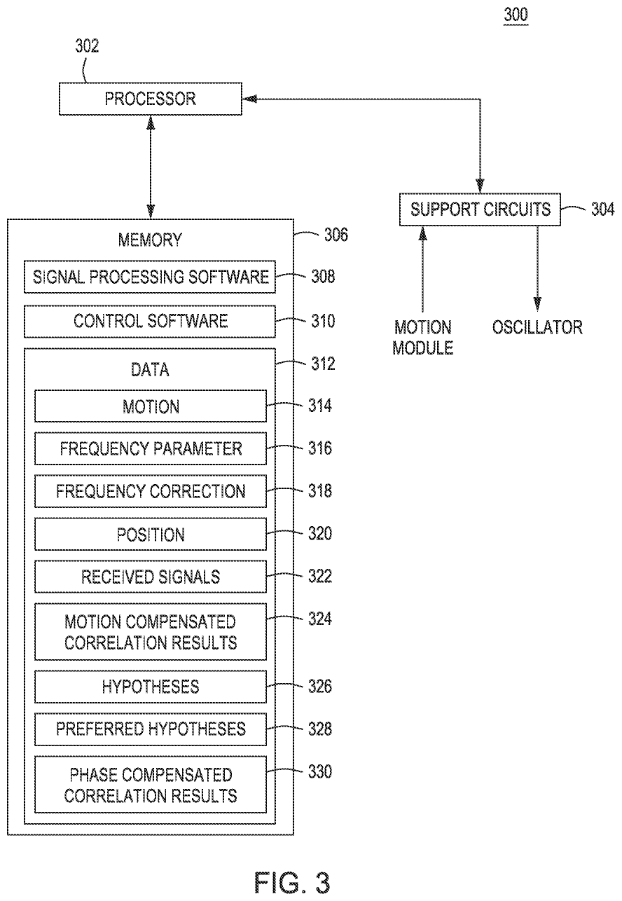

FIG. 3 depicts a block diagram of a computing device 300 for performing the function of the signal processor 206 and frequency source controller 208 in accordance with at least one embodiment of the invention. The computing device 300 comprises at least one processor 302, support circuits 304 and memory 306. The at least one processor 302 may be any form of processor or combination of processors including, but not limited to, central processing units, microprocessors, microcontrollers, field programmable gate arrays, graphics processing units, digital signal processors, and the like. The support circuits 304 may comprise well-known circuits and devices facilitating functionality of the processor(s). The support circuits 304 may comprise one or more of, or a combination of, power supplies, clock circuits, analog to digital converters, communications circuits, cache, drivers, and/or the like.

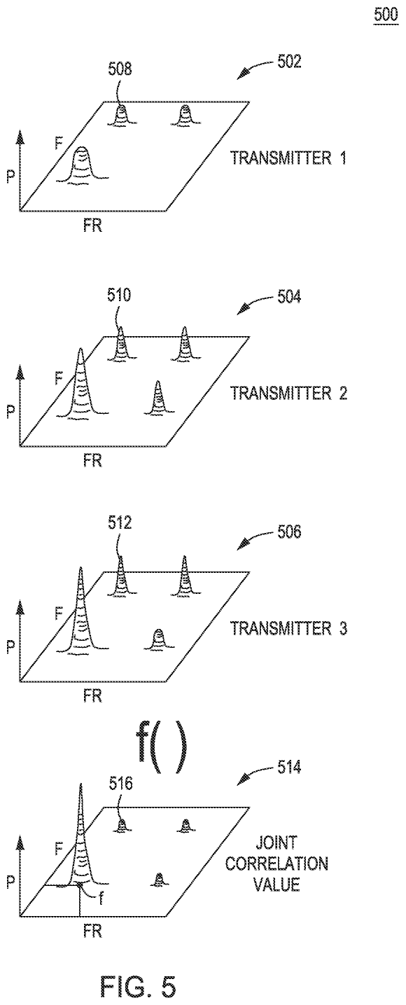

The memory 306 comprises one or more forms of non-transitory computer readable media including one or more of, or any combination of, read-only memory or random-access memory. The memory 306 stores software and data including, for example, signal processing software 308, control software 310 and data 312. The signal processing software 308, when executed by the one or more processors 302, performs motion compensated correlation upon the received signals to estimate the frequency source frequency error (i.e., frequency and frequency rate). The motion compensated correlation process is described in detail below with respect to FIG. 5. The operation of the signal processing software 308 and the control software 310 respectively function as the signal processor 206 and frequency source controller 208.

The data 312 stored in memory 306 may also include, but not limited to motion information 314, frequency related parameter 316, frequency correction 318, position 320, receiver signals 322, motion compensated correlation results 324, hypotheses 326, preferred hypotheses 328, and phase compensated correlation results 330 as well as data used in signal processing such as signal estimates, correlation results, motion compensation information, and the like. In some embodiments, the hypotheses 326 may include a prediction model, a lookup table, and prediction data for the prediction model.

As described in detail below, the signal processing software 308 uses a SUPERCORRELATION™ technique as described in commonly assigned U.S. Pat. No. 9,780,829, issued 3 Oct. 2017; U.S. Pat. No. 10,321,430, issued 11 Jun. 2019; U.S. Pat. No. 10,816,672, issued 27 Oct. 2020; U.S. patent publication 2020/0264317, published 20 Aug. 2020; and U.S. patent publication 2020/0319347, published 8 Oct. 2020, which are hereby incorporated herein by reference in their entireties, to determine at least one frequency related parameter. The motion information 314 from the motion module (212 in FIG. 2) is used to perform motion compensated correlation on the received signals 322 to produce motion compensated correlation results. From the motion compensated correlation process, the signal processing software 308 estimates at least one frequency related parameter (e.g., frequency error or offset) and, in one embodiment, the control software 310 produces a frequency correction to be applied to the oscillator or the oscillator signal. In other embodiments, the at least one frequency related parameter is used in the digital processing of the received signals to improve signal processing.

More specifically, embodiments of the invention may use motion estimation to motion compensate the signals received from each transmitter for the receiver motion component along the direction of signal propagation from the transmitter to the receiver such that the remaining phase errors are substantially due to the local frequency source error contribution to each received signal. By knowing the local source frequency error, a frequency error offset or correction value may be applied to compensate for the error to enable the source to create a more accurate frequency that is used in the signal correlation process. In other embodiments, the frequency error may be applied as a phasor to the motion compensated correlation results to produce very accurate phase compensated correlation results. In one embodiment, these phase compensated correlation results may be used by the GNSS receiver for position location calculations. As such, by using a frequency correction technique as described with respect to FIG. 5, a lesser quality frequency source (e.g., the source frequency significantly drifts in view of temperature changes, vibration, physical shock, power supply variation, etc.) may be used in the receiver. For example, rather than use a temperature compensated crystal oscillator (TCXO), using the embodiments described herein allows for the use of a less accurate, but low cost, voltage-controlled crystal oscillator (VCXO) or temperature-sensing crystal (TSX).

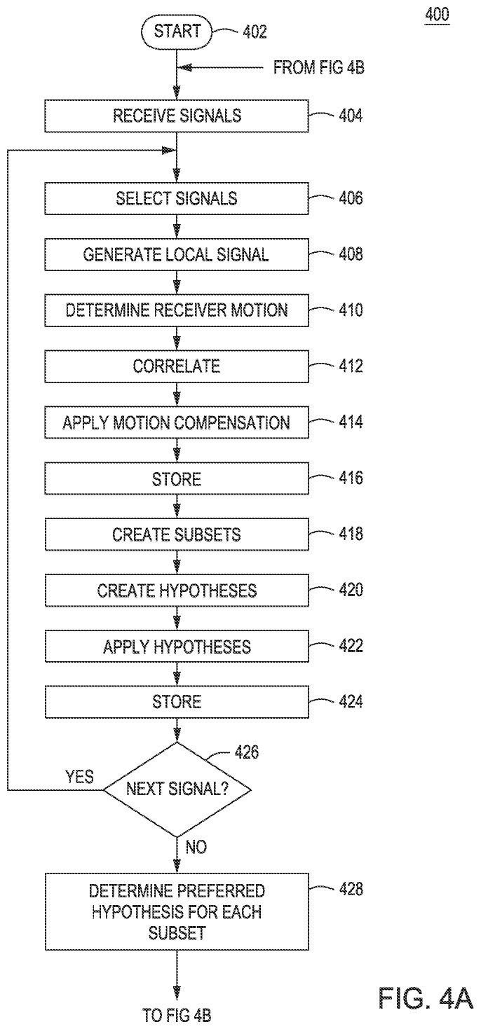

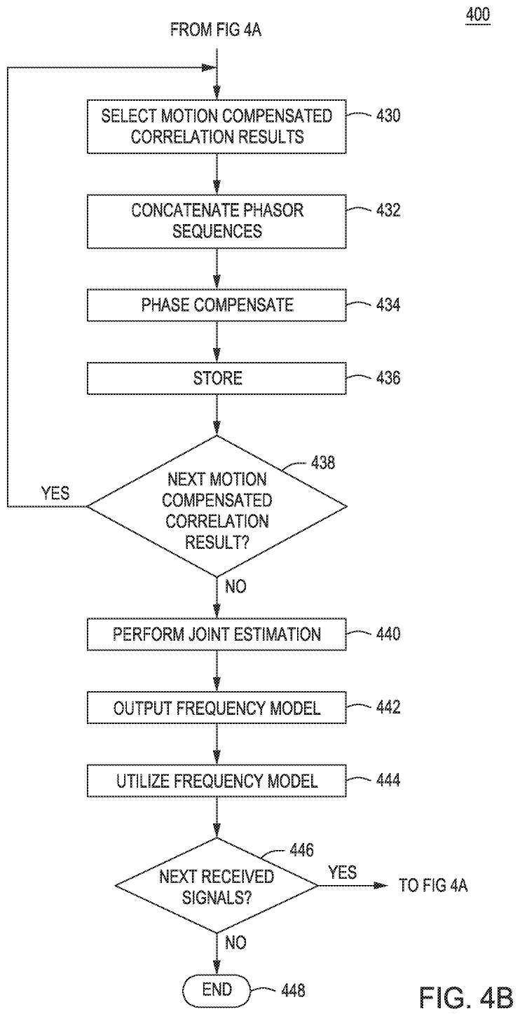

FIGS. 4A and 4B depict a flow diagram of a method 400 for determining frequency related errors produced by a frequency source within a receiver of FIGS. 1 and 2 in accordance with at least one embodiment of the invention. Each block of the flow diagram may represent a module of code to execute and/or combinations of hardware and/or software configured to perform one or more processes described herein. Though illustrated in a particular order, the following figures are not meant to be so limiting. Any number of blocks may proceed in any order (including being omitted) and/or substantially simultaneously (i.e., within technical tolerances of processors, etc.) to perform the operations described herein.

The method 400 performs three subprocesses: 1) use the motion of the receiver to motion compensate the correlation results from correlating an interval of the received signals with local signals to produce a set of motion compensated correlation results, 2) perform phase compensation using subsets of the motion compensated correlation results and subinterval phasor sequences, and 3) perform full coherent integration interval phase compensation using concatenated subintervals of phasor sequences identified in subprocess 2). The resulting correlation results are motion compensated for receiver motion and are adjusted for any frequency source errors across the entire coherent integration interval. Consequently, the receiver accurately correlates the received signals over a long coherent integration interval even though the frequency source has significant errors across the interval.

The method 400 begins at 402 and proceeds to 404 where signals are received from a plurality of remote sources, such as, for example, GNSS satellites. The received signals are typically buffered for use in subsequent repetitive processing. The signals are received over a predefined interval, i.e., the desired coherent integration period. Each received signal comprises a synchronization or acquisition code, e.g., a Gold code, extracted from the radio frequency (RF) signal received at the antenna. The process of downconverting the RF signal, sampling the signals and extracting the digital code is well known in the art.

At 406, the method 400 selects one of the received signals for processing, i.e., select a received signal from a particular satellite from the plurality of signals received from the plurality of satellites. Although the following description describes the method 400 as sequentially processing each received signal of the plurality of received signals, in some embodiments, the method may process all the received signals in parallel.

At 408, the method 400 generates a local signal using the local frequency source as a local frequency reference signal. The local signal includes a locally generated code which matches the expected code encoded in the received signal.

At 410, the method 400 receives motion information from the motion determination module 122 of FIG. 2. The motion information comprises an estimate of the motion of the receiver 102 of FIG. 1, e.g., one or more of velocity, heading, orientation, etc. The important motion information is the component of receiver motion along the direct propagation path between the receiver and the remote source (e.g., satellite). The motion in the direction of the transmitter causes a Doppler frequency variation in the received signal. Removing the effect of this motion significantly improves the reception and/or processing of the received signals.

At 412, the method 400 correlates the local signal with the selected received signal to produce a first correlation result. In one embodiment for receiving GNSS signals, the correlation periods may be 5 ms and result in 200 correlation peaks over a 1 second period (i.e., the desired coherent integration interval). The correlation results are complex values containing in-phase (I) and quadrature (Q) components. At 414, the method 400 motion compensates the selected received signal to form motion compensated correlation results. In one embodiment, the motion compensation technique used is the SUPERCORRELATION technique referenced above which applies a phasor sequence (i.e., a sequence of phase offsets applied to each complex valued correlation result). In other embodiments, the phasor sequence may be applied to the received signal, local signal, correlation results, or a combination of those signals to produce motion compensated correlation results. At 416, the method temporarily stores the motion compensated correlation results. These motion compensated correlation results over the desired coherent integration period form a set of results, e.g., 200 motion compensation correlation results in a 1 second coherent integration interval.

At 418, the method 400 divides the set of motion-compensated correlation results into a sequence of subsets. In one embodiment, a 1 second interval may be divided into five 0.2 second subintervals, i.e., a set of 200 results are divided into subsets of 40 results. Broadly speaking, the set may be divided into N subsets, where N is an integer. In one embodiment, the number of results in a subset may be defined by an estimated stability period of the frequency source. In some embodiments, N is predefined and fixed. In other embodiments, N may be variable based on, for example, measurements of the stability of the frequency source such that the number of subsets change as the stability of the frequency source changes as described in detail below. Other measurements that may be used to set the value of N include temperature, acceleration, and the status of other modules within the system such as processors, and WiFi and cellular transceivers. In other embodiments, the subsets may overlap, e.g., each subset of 40 results includes a number of results, for example, 20 results, from an adjacent subset. In further embodiments, the length of the subsets may vary within an interval.

At 420, the method 400 generates a plurality of phasor sequence hypotheses related to a frequency-related parameter of the frequency source. In one embodiment, the frequency-related parameter may be a frequency offset, where the frequency offset is the error between the current frequency of the frequency source and the true frequency needed to maximize the correlation value of the received signal (e.g., the GNSS satellite atomic clock frequency). In another embodiment, the frequency-related parameter may be a frequency offset and a frequency rate offset, where the frequency rate is a slope of the change in frequency over time and the frequency rate offset is the error in the rate. Each phasor sequence hypothesis comprises a time series of phase offset estimates that vary with the frequency-related parameters of the frequency source. A group of hypotheses are created for each subset of motion compensated correlation results.

For the motion compensated correlation results of each received signal, at 422, the method 400 uses a group of frequency-related hypotheses containing estimates of the phase offset sequences to phase compensate the motion compensated correlation results over the subset (e.g., 40 motion compensated correlation results) in order to maximise the coherently-integrated correlation result over the subset, wherein the coherently-integrated correlation result is the summation of the phase-compensated correlation results. There is a group of frequency-related hypotheses representing a search space for each subset of motion compensated correlation results.

As discussed above, the particular error in the frequency source 210 may be influenced by its environment and the conditions under which it operates. Therefore, storing previously calculated offsets in the lookup table of the hypotheses 326 may enable subsequent offset calculations to benefit from the knowledge of how the frequency source 210 behaved in similar conditions in the past. The lookup table may be used to reduce the processing load involved in calculating the error in the frequency source 210 by considering previous offsets in the local frequency reference provided by the frequency source 210.

The lookup table may be a dataset configured to store the frequency or phase offsets that have been measured during previous uses of the receiver 102 in particular operating conditions. In this embodiment, the lookup table is a multidimensional array that stores calculated frequency and frequency rate offset value pairs corresponding to particular operating conditions.

Some operating conditions, such as whether a particular component (e.g., the touch screen or wireless interface) of the receiver 102 is in operation may be characterised with a binary operating parameter. For example, a touchscreen can only be on or off, and the operating parameter may take a value of one or zero. Other types of measurements may be continuous, such as the degree of vibration or the temperature of the frequency source 210. For these continuous variables, the lookup table may be configured to use a bin width, such that measurements of an operating condition within the bin width correspond are considered the same measurement for the purposes of storing relevant offset calculations. This may be useful to maintain the lookup table at a manageable length, and hence a manageable storage size. In other embodiments, the lookup table may be configured so that certain dimensions of the lookup table have a length corresponding to a sensor resolution. For example, a dimension of the lookup table corresponding to temperature may have a length equal to the measuring range of a temperature sensor divided by its resolution. This would allow a pair of offsets to be stored for every possible sensor value.

In one specific example, the local offset calculator may determine the particular error in the local frequency reference produced by the frequency source 210 during operating conditions of: a local oscillator temperature of 20° C., the screen being in an “on” state, and substantially no jolting of the receiver 102. The local offset calculator may then add the calculated offset values to a corresponding location in the lookup table corresponding to these operating conditions. In a subsequent calculation, the local oscillator offset calculator may, for example, determine offsets for operating conditions that differ in respect of temperature, i.e., conditions of: frequency source 210 temperature of 15° C., the screen being in operation, and substantially no jolting of the receiver 102 The calculated offsets for these conditions may be stored in a different location in the lookup table. In this manner, over time, the lookup table may store the results of offset calculations performed across a wide space of operating conditions.

In another simplified example, the local oscillator offset calculator may only consider the operating conditions of (i) temperature, and (ii) whether a touchscreen is in operation. In this case, the lookup table may be configured as a three dimensional array (A×B×C). One dimension, A, may correspond to the temperature of the frequency source 210, and may have a length equal to the number of temperature bins in use. In this simplified example, four bins of temperature may be in use, and the lookup table may have a corresponding dimension length of four. Another dimension, B, may correspond to the state of the screen, and thus would have a length of two since the screen can only be on or off. The remaining dimension, C, corresponds to the frequency offset and the frequency rate offset measured under the corresponding operating conditions. Thus, the dimension C has a length of two to store two different offset values for every possible combination of screen state and temperature bin. In this example, the lookup table can therefore be implemented as a matrix of values of dimensionality (4×2×2) storing either frequency offsets in the (i, j, 1) slice and frequency rate offsets in the (i, j, 2) slice, for arbitrary matrix indices i and j.

In more involved embodiments, the lookup table may typically have a higher dimensionality according to the number of additional operating parameters (e.g., degree of device jolting, acceleration or vibration, etc) that are factored into account. For example, if the presence of vibrations in the frequency source 210 is also factored in, the lookup table may be a four dimensional matrix or data structure.

In one specific more involved embodiment, the lookup table may also account for whether the temperature is increasing or decreasing. This is because oscillators can exhibit temperature hysteresis, i.e., can behave differently at a given temperature depending on the recent or historical temperature of the oscillator. For example, the frequency source 210 may provide a relatively lower frequency reference when the temperature is at 20° C. and increasing, and a relatively higher frequency reference when the temperature is at 20° C. and decreasing. The lookup table can be configured to store offset values for each case of increasing or decreasing temperature.

Continuing the above example, the lookup table can have an additional dimension Z of length 2, providing an array of (A×Z×B×C) so that each temperature value has two corresponding frequency and frequency rate offset entries in the lookup table. One pair of frequency and frequency rate offsets would correspond to when the frequency source 210 is at a respective temperature and the temperature is increasing. The other pair would correspond to the same temperature but when the temperature is decreasing. The additional dimension in this case could be embodied as a binary dimension, i.e. taking values of 1 or 0 only, similar to the operating condition of whether the touchscreen is in operation. This allows the lookup table to account for temperature hysteresis effects in the frequency source 210.

In practice, a much greater number of bins for continuous variables may be used than the four temperature bins in the above example. In the above example, the dimension C could have a greater or shorter length depending on the order of frequency corrections in use. For example, the dimension C could have a length of one if only frequency offsets are applied, or could have a length of three if both first and second time derivative corrections are calculated and applied.

In other embodiments, the lookup table could be any form of dataset implemented in a variety of other ways, such as using other forms of data structures, or using a plurality of separate matrices or other data structures. For example, the lookup table could be implemented using a table to store specific measurement values for each operating condition corresponding to a particular time period. In addition, the table may store the corresponding offset values calculated for these conditions and the particular time period. Thus, a list of measured operating conditions and the corresponding offset values calculated subsequently may be built up over time by the local oscillator offset calculator in the lookup table. In this case, when referring to the lookup table at a later time, the local oscillator offset calculator may refer to the closest set of operating condition measurements in the list in order to restrict a “search space”, as discussed further below.

In some embodiments, the lookup table may be configured to store a plurality of offset values for the same operating conditions and store additionally an average offset value for those conditions. The average offset for particular conditions may be calculated by the local oscillator offset calculator. The average offset value for particular conditions may then be used to set a search space or window width, as discussed further below. Alternatively, only the most recent offset values determined for a particular set of conditions may be stored, and thus subsequent measurements in the same operating conditions may overwrite previously measured offsets.

Another approach that can be used in place of or in conjunction with the lookup table involves the use of the prediction model. The prediction model can include a mathematical formula or AI-based model, such as a neural network or machine learning model, that is able to make an initial estimate or initial prediction of the error in the frequency source 210 based on the determined operating conditions. In any case, the prediction model allows future behaviour of the frequency source 210 to be predicted through a characterisation of past behaviour. The prediction model can be used in a similar manner as the lookup table to provide an initial frequency estimation that constrains a search space or window for calculating the frequency offset more precisely, as explained in further detail below. Use of such a model can also be referred to as using “predictive control”.

The model can be pre-trained with prediction data stored in the memory 306, or continuously retrained based on the determined operating conditions and each calculated frequency offset. Alternatively, the model can incorporate data from the lookup table. If a pre-trained model is used that is not continuously re-trained or updated based on calculated frequency offsets, it may not be necessary to store each calculated offset and the corresponding operating conditions. Continuously retraining the model would enable the model to be tailored to the particular device in which it is implemented.

Data from sensors or determinations made by the controller may be used to control operational functions of the receiver 102 to mitigate operating conditions that negatively affect the stability of the frequency source 210. For example, if a sensor indicates the frequency source 210 temperature is becoming extreme to the point of making phase compensation a non-viable option to correct for the temperature, the controller may inform the receiver 102 to perform a mitigating action to lower the temperature, e.g., deactivate the screen, slow the processor speed, deactivate one or more modems, etc.

The search space or window size can also be constrained in other ways. In one example incorporating the prediction model, the prediction model can determine a confidence or variability score based on the determined operating conditions. The score can represent the variability of the frequency source 210 in the corresponding operating conditions. A high score can indicate that the frequency source 210 is particularly unstable and that a wider search space should be used. Conversely, a lower score may indicate that a narrower search space can be used because the frequency source 210 is known to be somewhat more stable in the current conditions.

In another example, the prediction model can compare the frequency offset most recently calculated with a more recent frequency offset prediction. The size of the difference between the more recent prediction and the most recently calculated value can define the size of the search space or window. For example, if the prediction and current values are very different, the number of hypotheses may be expanded. Conversely, if the difference is small, a lesser number of hypotheses may be used.

At 422, phase compensation is applied to each of the N subsets of motion compensated correlation results. The hypotheses are used as parameters to form a plurality of phase-compensated phasors to phase compensate the motion compensated correlation results. For each subset, a search is performed over frequency and frequency rate (i.e., a search using B frequency hypotheses and C frequency rate hypotheses) to determine the “best fit” frequency and frequency rate hypothesis for each subset. The application of each hypothesis results in a phase-compensated correlation result for a given subset of motion compensated correlation results. As such, for each subset, the search space has B×C hypotheses that produce B×C phase compensated correlation results for each of the N subsets.

At 424, the subsets of phase compensated correlation results are temporarily stored. Note that, although 406 through 424 are described as being sequentially performed, in other embodiments, they may be performed in parallel.

At 426, the method queries whether the next received signal is to be processed. The next received signal is a signal received from a different signal source (e.g., different satellite) in the same time period as the prior processed signal. For a given time interval, there are X number of received signals from X different transmission sources (e.g., satellites 106-1, 106-2, 106-3 of FIG. 1). If the query is affirmatively answered, the method 400 returns to 406 to select the next received signal to process. If the query is negatively answered (i.e., all received signals in the current time instant have been processed), the method 400 proceeds to 428.

At 428, the method 400 performs joint estimation such that the phase compensated correlation results are combined (e.g., summed) to determine the hypotheses that maximize the correlation value of the phase compensated correlation results. The joint estimation process is described below with reference to FIG. 5. For each subset, a frequency and frequency rate preferred hypothesis is determined.

At 428, the method 400 determines a preferred hypothesis for each of the subintervals using a joint correlation technique. The method 400 produces a joint correlation output (e.g., summation, weighted summation, or other function) for each subinterval as a function of the plurality of phase compensated correlation results resulting from all the hypotheses and received signals. The joint correlation output may be a single value or a plurality of values that represent the parameters that provide an optimal or best phase compensated correlation output. The joint correlation output contains estimates of the frequency-related parameters. All received signals have different receiver motion compensation because the receiver is moving differently with respect to each remote source, but all the received signals are processed with the same, common frequency error that can be found, for example, by stacking (summing) the plurality of correlation results associated with each subinterval and finding a common joint correlation value. This may be the global maximum or a local maximum depending on the cost function employed in combining the signals into the joint estimator. Example functions are a simple summation, or a weighted summation using satellite elevation or another metric for the weightings. In this manner, the method 400 determines the frequency and frequency rate values for each of the subset hypotheses that generate a joint correlation value having, for example, the largest magnitude or meets some other sufficiency criteria.

FIG. 5 depicts a schematic diagram of the method 500. The phase compensated correlation results for transmitter 1 are shown at 502, for transmitter 2 at 504 and for transmitter 3 at 506. Each plot is a three-dimensional representation of the frequency (F) and frequency rate (FR) search space and the power (P) in the correlation values. Each transmitter has a peak correlation value 508, 510 and 512 at a particular frequency and frequency rate. The summation of all the results is shown as plot 514 and forms the joint correlation output. The joint correlation output contains estimates of various system parameters, and different functions applied to it can be used to recover them. For example, the LOS components from each signal all accumulate within a common bin within the search space 416, revealing the local oscillator frequency and frequency rate offset for that epoch. The offsets from this “calibration point” to other bins in the search space containing non-insignificant power can be used to determine the azimuth and elevation that those NLOS signals arrive from. The frequency and frequency rate at the location of the joint correlation value are used to compensate for the frequency error of the local frequency source. All received signals have different receiver motion compensation because the receiver is moving differently with respect to each transmitter, but all the received signals are processed with the same, common frequency error that can be found by stacking (summing) the plurality of correlation values associated with each transmitter and finding a common joint correlation value. This may be the global maximum or a local maximum depending on the cost function employed in combining the signals into the joint estimator. Example functions are a simple summation, or a weighted summation using satellite elevation or another metric for the weightings. In this manner, the method 500 determines the frequency and frequency rate values of the hypotheses that generate a joint correlation value having the largest magnitude.

In other embodiments, rather than using the largest magnitude correlation value, other test criteria may be used. For example, the method 400 may monitor the progression of correlations as hypotheses are tested and apply a cost function that indicates the best hypotheses when the cost function reaches a minimum (e.g., a small hamming distance amongst peaks in the correlation plots). As such, the joint correlation output that indicates the preferred hypothesis to be used for each subinterval may be a joint correlation value or a group of values. For each subinterval, there is a preferred hypothesis matrix representing an optimal phasor sequence to apply to a given subinterval of motion compensated correlation results.

At 430, the method 400 selects one of the sets of motion compensated correlation results (e.g., from one of the remote sources) that were temporarily stored at 416. Although the motion compensated correlation results are described as being processed sequentially, in other embodiments they may be processed in parallel.

At 432, the method 400 concatenates and smooths (e.g., using a polynomial best fit or similar expression) the subset phasor sequences from each preferred hypothesis to create a frequency/frequency rate model that extends over the entire coherent integration interval (e.g., 1 second).

At 434, the method 400 phase compensates the motion compensated correlation results by applying the interval length frequency-frequency rate model to the motion compensated correlation results. In one embodiment, the frequency-frequency rate model is used to adjust the phase of each complex valued correlation result. The method 400 applies each phase offset in the model to a corresponding complex sample in the motion compensated correlation result.

At 436, the phase compensated correlation results for the entire interval are temporarily stored for subsequent use. At step 438, the method queries whether the next set of correlation results for a different received signal is to be processed. If the query is affirmatively answered, the method 400 returns to 430 to select the next set of motion compensated correlation results to process. If the query is negatively answered (i.e., all motion compensated received signals have been processed), the method 400 proceeds to 440.

At 440, the method 400 jointly analyses the phase compensated correlation results associated with all the received signals to determine a final frequency and frequency rate error model for the entire coherent integration interval. The method 400 produces a joint correlation output for the interval as a function (e.g., summation) of the plurality of phase compensated correlation values resulting from the concatenated preferred hypotheses and the motion compensated correlation results for each received signal. The joint correlation output may be a single value or a plurality of values that represent the parameters that provide an optimal or best correlation output. The joint correlation output contains estimates of frequency related parameters. All received signals have different receiver motion compensation because the receiver is moving differently with respect to each transmitter, but all the received signals are processed with the same, common frequency error that can be found by stacking (summing) the plurality of phase compensated correlation values associated with a given interval of received signal and finding a common joint correlation value. This may be the global maximum or a local maximum depending on the cost function employed in combining the signals into the joint estimator. Example functions are a simple summation, or a weighted summation using satellite elevation or another metric for the weightings. In this manner, the method 400 determines the frequency and frequency rate values of the interval hypothesis (concatenated subinterval hypotheses) that generate a joint correlation value having the largest magnitude.

In other embodiments, rather than using the largest magnitude correlation value, other test criteria may be used. For example, the method 400 may monitor the progression of correlations across all received signals and apply a cost function that indicates the common frequency and frequency rate error when the cost function reaches a minimum (e.g., a small hamming distance amongst peaks in the correlation plots). As such, the joint correlation output may be a joint correlation value or a group of values.

At 442, the method 400 outputs the frequency and frequency rate error of the local frequency source, e.g., the difference between the hypothesised frequency and the local source frequency. In one embodiment, the method 400 interpolates over the, for example, 200 frequency/frequency rate samples and produces a frequency model for the frequency source over the coherent integration period. At 444, the method 400 uses the frequency model. In one embodiment, the frequency model may be used within a navigation engine to correct frequency and receiver motion induced errors in the positioning solution. In other embodiments, the model and/or the discrete frequency/frequency rate samples may be used for other purposes such as modelling the local frequency source in view of environmental changes (e.g., temperature, physical shock, received component activation and the like). Consequently, embodiments of the invention may predict changes in the frequency and frequency rate as a result of environmental changes.

At 446, the method 400 queries whether a next received signals in a subsequent coherent integration period are to be processed. If the query is affirmatively answered, the method 400 proceeds to 404 of FIG. 4A. If the query is negatively answered, the method 400 ends at 448.

Embodiments of the invention may be used to decrease the cost (i.e., bill of materials (BOM)) of a receiver. As described above, a receiver with an unstable frequency source (e.g., low cost oscillator) which uses embodiments of the invention may be used to accurately receive accurately positioning and/or communications signals over long coherent integration periods. Without using embodiments of the invention, such a low cost frequency source could not be used.

Here, multiple examples have been given to illustrate various features and are not intended to be so limiting. Any one or more of the features may not be limited to the particular examples presented herein, regardless of any order, combination, or connections described. In fact, it should be understood that any combination of the features and/or elements described by way of example above are contemplated, including any variation or modification which is not enumerated, but capable of achieving the same. Unless otherwise stated, any one or more of the features may be combined in any order.

As above, figures are presented herein for illustrative purposes and are not meant to impose any structural limitations, unless otherwise specified. Various modifications to any of the structures shown in the figures are contemplated to be within the scope of the invention presented herein. The invention is not intended to be limited to any scope of claim language.

Where “coupling” or “connection” is used, unless otherwise specified, no limitation is implied that the coupling or connection be restricted to a physical coupling or connection and, instead, should be read to include communicative couplings, including wireless transmissions and protocols.

Any block, step, module, or otherwise described herein may represent one or more instructions which can be stored on a non-transitory computer readable media as software and/or performed by hardware. Any such block, module, step, or otherwise can be performed by various software and/or hardware combinations in a manner which may be automated, including the use of specialised hardware designed to achieve such a purpose. As above, any number of blocks, steps, or modules may be performed in any order or not at all, including substantially simultaneously, i.e., within tolerances of the systems executing the block, step, or module.

Where conditional language is used, including, but not limited to, “can,” “could,” “may” or “might,” it should be understood that the associated features or elements are not required. As such, where conditional language is used, the elements and/or features should be understood as being optionally present in at least some examples, and not necessarily conditioned upon anything, unless otherwise specified.

Where lists are enumerated in the alternative or conjunctive (e.g., one or more of A, B, and/or C), unless stated otherwise, it is understood to include one or more of each element, including any one or more combinations of any number of the enumerated elements (e.g. A, AB, AC, ABC, ABB, etc.). When “and/or” is used, it should be understood that the elements may be joined in the alternative or conjunctive.

While the foregoing is directed to embodiments of the present invention, other and further embodiments of the invention may be devised without departing from the basic scope thereof, and the scope thereof is determined by the claims that follow.

1. A method for determining a frequency related parameter of a local frequency source within a receiver, comprising:
receiving a plurality of signals from a plurality of remote sources;
generating motion compensated correlation results using a determined receiver motion, the received signals, and a local signal derived from the local frequency source;
phase compensating the motion compensated correlation results to produce phase compensated correlation results using a plurality of phasor sequences that represent frequency error of the local frequency source; and
jointly analysing the phase compensated correlation results associated with the plurality of remote sources to determine a frequency related parameter of the local frequency source.

2. The method of claim 1, wherein for each signal, the determined receiver motion includes an estimate of a component of motion of the determined receiver along a direct propagation path between a receiver and a remote source of the signal.

3. The method of claim 1, wherein each phasor sequence has a length that is defined by an expected stability of the local frequency source.

4. The method of claim 1, wherein the frequency related parameter of the local frequency source includes at least one of a frequency or frequency rate.

5. The method of claim 1, wherein the phase compensating includes creating subsets of the motion compensated correlation results, and for each subset, applying the phasor sequences as frequency related hypotheses to the motion compensated correlation results over the subset.

6. The method of claim 5, wherein the phase compensating includes determining a preferred frequency related hypothesis for each subset; and concatenating the preferred frequency related hypotheses of each subset to form a phasor sequence having a length of a predefined coherent integration period.

7. The method of claim 1, wherein the jointly analysing includes summing the phase compensated correlation results and identifying a common joint correlation value.

8. Apparatus for performing signal correlation within a signal processing system, comprising at least one processor and at least one non-transient computer readable medium for storing instructions that, when executed by the at least one processor, causes the apparatus to perform operations comprising:
receiving a plurality of signals from a plurality of remote sources;
generating motion compensated correlation results using a determined receiver motion, the received signals and a local signal derived from a local frequency source;
phase compensating the motion compensated correlation results to produce phase compensated correlation results using a plurality of phasor sequences that represent frequency error of the local frequency source; and
jointly analysing the phase compensated correlation results associated with the plurality of remote sources to determine a frequency related parameter of the local frequency source.

9. The apparatus of claim 8, wherein for each signal, the determined receiver motion includes an estimate of a component of motion of the determined receiver along a direct propagation path between a receiver and a remote source of the signal.

10. The apparatus of claim 8, wherein each phasor sequence has a length that is defined by an expected stability of the local frequency source.

11. The apparatus of claim 8, wherein the frequency related parameter of the local frequency source includes at least one of a frequency or frequency rate.

12. The apparatus of claim 8, wherein the phase compensating includes creating subsets of the motion compensated correlation results, and for each subset, applying the phasor sequences as frequency related hypotheses to the motion compensated correlation results over the subset.

13. The apparatus of claim 12, wherein the phase compensating includes determining a preferred frequency related hypothesis for each subset; and concatenating the preferred frequency related hypotheses of each subset to form a phasor sequence having a length of a predefined coherent integration period.

14. The apparatus of claim 8, wherein the jointly analysing includes summing the phase compensated correlation results and identifying a common joint correlation value.

15. One or more non-transitory computer readable media having instructions stored thereon which, when executed by one or more processors, cause the one or more processors to perform operations comprising:
receiving a plurality of signals from a plurality of remote sources;
generating motion compensated correlation results using a determined receiver motion, the received signals and a local signal derived from a local frequency source;
phase compensating the motion compensated correlation results to produce phase compensated correlation results using a plurality of phasor sequences that represent frequency error of the local frequency source; and
jointly analysing the phase compensated correlation results associated with the plurality of remote sources to determine a frequency related parameter of the local frequency source.

16. The computer readable media of claim 15, wherein for each signal, the determined receiver motion includes an estimate of a component of motion of the determined receiver along a direct propagation path between a receiver and a remote source of the signal.

17. The computer readable media of claim 15, wherein each phasor sequence has a length that is defined by an expected stability of the local frequency source.

18. The computer readable media of claim 15, wherein the frequency related parameter of the local frequency source includes at least one of a frequency or frequency rate.

19. The computer readable media of claim 15, wherein the phase compensating includes:
creating subsets of the motion compensated correlation results; and
for each subset, applying the phasor sequences as frequency related hypotheses to the motion compensated correlation results over the subset; and determining a preferred frequency related hypothesis for each subset; and concatenating the preferred frequency related hypotheses of each subset to form a phasor sequence having a length of a predefined coherent integration period.

20. The computer readable media of claim 15, wherein jointly analysing includes summing the phase compensated correlation results and identifying a common joint correlation value.
